(19) United States
(12) Patent Application Publication
(10) Pub. No.: US 2024/0174160 A1
(43) Pub. Date: May 30, 2024

(54) Amphibious water tanker tractor-trailer pumping 100,000 GPH and hauling 100-ton flood and firefighting water over land and lake

(71) Applicant: Yona Becher, Budd Lake, NJ (US)

(72) Inventor: Yona Becher, Budd Lake, NJ (US)

(21) Appl. No.: 18/445,591

(22) Filed: Nov. 9, 2023

(51) Int. Cl. B60P 3/22; B60F 3/00; B63B 25/08; B63H 11/08

(52) U.S. Cl. CPC B60P 3/2205; B60F 3/0015; B60F 3/0092; B60P 3/225; B63B 25/08; B63H 11/08

(57) ABSTRACT

An amphibious water tanker of 100-ton water capacity with two propelling and pumping modules hooked up at each side with pneumatic air-turbine engines powered by Archimedes-Screw pumps capable of pumping 100,000 GPM flood water into a floatation-controlled water tanker and out from the water tanker to a water consumer including agriculture. Four Caterpillar belts-driven units, each with eight toothed wheels driven by pneumatic air turbine engines using auxillary air tanks compressed air to propel the amphibious water tanker in all directions, with the tanker rolling on 140 load supporting sphere tires. Four air-turbine engines with marine propellors propel the self-inflated floatable amphibious water tanker in the shallow or deep water of a flooded river or lake. The water tanker is built locally with helical hardwood bars bolted together and each adjacent helical turn bolted to create a cylindrical 4.5-meter diameter 10-meter long, each with inlet and outlet-controlled valves.

### BACKGROUND OF THE INVENTION

Undoubtedly, during recent decades, with the global warming of the planet, more floods have occurred almost daily worldwide due to significantly stronger than usual rain storms, which keep raining for hours and even days at high rain rates, therefore causing rapid water accumulation in undrained areas. The large amount of water accumulation in specific areas turns to disastrous floods without any means to drain the water into a river or a reservation. In many cases, the existing local sewer system in dwelling areas and cities cannot handle large volumes of water during a short period of time. In addition, the waterflow rates in many rivers are slow due to debris and plants growing within the river flow area, causing overflowing of the river before the river connects to the ocean. A rainstorm of more than 4 inches of rain per hour locally during hours and days requires large water volume removal, including high flow rate pumping means and large water storage spaces to prevent fast accumulation of flood water together with a fast level rising of water above the ground. When the water level in the streets and around houses in densely populated dwelling areas reaches a certain level above ground level, the water flows rapidly over fences, entering lower levels of the dwelling rooms and basements. Water damage creates a significant property total loss of tens of millions of dollars in damage. In many cases, floods cause the loss of human and animal lives when the gushing water carries away cars occupied with people and causes the drowning of people trapped in the vehicles. When flood water rises and spills over the banks of a river due to along period of heavy rain, it significantly damages houses, industrial plants, public facilities, and lands, causing the loss of lives of people and animals that were trapped and drowned by the uncontrolled gushing of cold water flow. During recent years, global climate changes caused flooding and overflowing of many large rivers in the USA, South America, Africa, Asia, and around the world, causing significant damage and loss of lives in cities and towns along rivers. In addition, hurricanes and other large-scale storms move in a slow-moving path while pouring more than 4″ of rain every hour for days. Therefore, the sewer systems in cities and towns are overwhelmed with massive volumes of water. They are not capable of carrying out or draining the flood water from the flooded area and flowing it into a large storage reservoir pool.

Currently, there is no commercial large-scale amphibious water tanker with self-pumping means to pump 100,000 gallons of water per hour into a 100 tons self-storage capacity water tanker that can store the water locally and has amphibious means to transfer the water with hauling means to move the water away from the flooded area to another location where the water can be stored at least for the time needed for the flood water to recedes or subsidies. Therefore, one way to avoid flood damage and prevent large-scale flooding of a dwelling area when a large-scale rainstorm is expected is to bring on a tractor-trailer to a potential flood area an amphibious water tanker equipped with multiple pneumatic engine-operated high flow-rate Archimedes-screw water pumps and as they would start pumping water whenever the rain starts. A pre-emptive pumping of the water storing it in the amphibious water tanker, and hauling it away from the flooded area would prevent water accumulation on the ground and the rising and overflowing of flood water levels into dwelling areas. This would save billions of dollars and many human and animal lives annually in the US and around the world.

The main field of the invention is related to an amphibious water tanker with a storage volume of 100 tons of water and hauling it over a flooded area ground or while floating over a river or a lake, including a pneumatic engine powered self-pumping integral high-rate capacity of 100,000 Gallons Per Hour of flood water well as ocean seawater desalinated drinking water.

The other main field of the invention Is related to an amphibious water tanker with a storage volume of 100 tons of water for firefighting with an integral volume of 100 tons of water storage, including a pneumatic engine-powered water pump high-rate capacity of 100,000 Gallons Per Hour for putting out a fire in forests and dwelling areas, equipped with propelling module equipped with four pneumatic engines using tapered Archimedes Screw type water pumps with waterjet-trusters for propelling the amphibious water tank over water-covered areas such as lakes, reservoirs, and rivers.

The other main field of the invention is related to an amphibious water tanker with integral auxiliary air tanks filled with high-pressure air with the capacity to operate pneumatic engines, each powering pump and propelling pneumatic engine continuously for 4 hours before being recharged with compressed air from an extra external air tank for an additional 4 continuous operations with a charging time of less than 5 minutes. Another objective of the invention is to use zero-emission and fossil-free pneumatic engines that are pneumatically powered from auxiliary air tanks on the amphibious water tanker.

Another main objective of the invention is to provide an amphibious large-volume water tanker of 100 cubic meters with a fast water pumping rate of 100,000 gallons per hour for removing flooding water or for getting from a river, reservoir, or lake into built-in-place storage. The amphibious water tanker is equipped with a pump, and propelling means on land and a water reservoir propelled by a pumping and propelling module with four pneumatic engines attached to a towing wire cable. A control panel of the module electronically controls the operational speed and power of the four tapered Archimedes Screw-type water pumps with waterjet-trusters and the two lateral caterpillars' eight-toothed-wheel belted driving assemblies.

The rapid pumping and water propelling are achieved by four Archimedes screw-type water pumps, each powered continuously by a high-power pneumatic pulsed supersonic air-turbine engine that is powered by stored compressed air from air tank storage on the amphibious water tanker, which allows 4 hours of continuous pumping operation before recharging with external air tank source.

Furthermore, another objective of the invention is to provide a self-contained and self-powered amphibious water tanker ready at any flood area with high power fast pumping water at 100,000 gallons hours with a water storage capacity of 100 tons with means to haul the amphibious water tanker over land ground or overwater reservoir, river or lake to another location, through the flooded area.

A further objective of the invention is to provide an amphibious water tanker of 100-ton water storage capacity with an inclusive pumping capacity of 100,000 gallons per hour that can move on land and goat In flood water, rivers, and lakes, can propel itself and refilled its tanker with water across a lake or a water reservoir with sweet or seawater. Another objective of the invention is to provide an amphibious water tanker with a 100-ton water capacity with engine-powered high-rate water pumps for firefighting that can rapidly pump out the stored flood water from the amphibious water tank through manual high-flow flow control valves and transfer the water elsewhere where it is needed, including agriculture and as an emergency water source for putting out fires in wooded areas or close to populated areas,

Another objective of the amphibious water tanker with a 100-ton water capacity is to be self-propelled over ground or over a river, reservoir, or lake or towed from the flooded area either on land by loading it over a tractor-trailer or being hauled away floating over water from the flooded area to a new destination through a river or sea water, where water would be used for drinking or agriculture. At the same time, the amphibious water tanker has the means to adjust its floatation level to float and sail in flood or seawater.

### STATE OF THE ART

1. U.S. Pat. No. 8,550,022 B2 by Yona Becher, dated Oct. 8, 2013, titled: Transportable and built on-site container apparatus with controlled floatation and with self-collecting means for water flooding emergency
2. US patent application U.S. Ser. No. 17/803,601 by Yona Becher, filed Sep. 6, 2022, tilted: Pulsed Supersonic air-turbine Engine with speed control

### BRIEF SUMMARY OF THE INVENTION

An amphibious Water Tanker tractor-trailer with a fossil-free capability of pumping 100,000 GPH and hauling 100-ton flood and firefighting water over water and land. The amphibious water tanker pumps flood water at a high rate into a large self-container storage and is able to haul flood water and remove large volumes of flood water from flooded areas, preventing floodwater accumulation and overflowing into low-level dwellings. The amphibious water tanker provides firefighters with a high flow rate of high-pressure water needed to put out the fire quickly and efficiently. The amphibious water tanker is floatable with pressurized air-controlled floatation with self-propelling means over water and is capable of pumping water from rivers, water reservoirs, lakes, and flooded areas and storing it in the amphibious water tanker.

While floating over water, the amphibious water tanker is connected with high-strength multiple wire cables with a floating module, which provides the pumping means and propelling means over land and while floating over water such as a lake. The propelling module is equipped with four pneumatic engines that operate four doubled convergence divergence tapered Archimedes Screw-type water pumps with waterjet trusters pumps for propelling the amphibious water tank over water-covered areas such as lakes, reservoirs, and rivers. Mile located on land, such as in flooded areas, the amphibious water tanker with up to a 100-ton load of water is supported above ground by 140 spherical tires over land covered with water, such as flooded areas. The propelling module is equipped with two ground-propelling pneumatic engines that power two side-mounted belt caterpillars with eight-toothed wheeled belt drive assemblies.

A control panel of the module electronically controls the operational speed and power of the four tapered Archimedes Screw-type water pumps with waterjet-trusters and the two lateral caterpillars' eight-toothed-wheel belted driving assemblies.

List of parts and Reference Numbers in the Figures

| Part | | Figure |
|---|---|---|
| reference | | number |
| number | Part name description | location |
| 11 | amphibious water tanker trailer | 1, 2, 22 |
| 12 | amphibious tractor module | 1, 2, 19, |
| | | 20 |
| 13 | towing wire cable assembly | 5, 9, 11, |
| | | 20, 32 |
| 14 | amphibious water tanker container | 1, 4, 22 |
| 15 | water pump and truster-powered pneumatic | 2, 5, 20, |
| | engines | 30, 31 |
| 16 | Archimedes Screw-type water pumps | 23, 24, 25, |
| | | 26, 27 |
| 17 | Archimedes Screw-type water pump waterjet | 27, 28, 29, |
| | truster | 30, 31 |
| 18 | caterpillar-propelling pneumatic engines | 6, 17, 18 |
| 19 | side-mounted belt caterpillar | 5, 7, 8, 9, |
| | | 19 |
| 20 | eight-toothed wheeled belt drive assembly | 8, 9 |
| 20a | caterpillar belt driving assemblies | 8 |
| 21 | module control panel | 7, 10, 11, |
| | | 21 |
| 23 | tanker water tube | 35, 36 |
| 24 | helically curved hardwood bar | 35, 36 |
| 25 | tube longitudinal centerline | 36 |
| 26 | helically curved hardwood bar cross-section | 37 |
| 27 | helically curved hardwood bar open ends | 37 |
| 28 | identical concentric helically curved hard- | 37 |
| | wood bar | |
| 29 | helically bent hardwood bar support | 37 |
| 30 | helically curved hardwood bar turns | 37 |
| 31 | right and left side joining flanges | 37 |
| 32 | central semi-circular top balloon cut | 37 |
| 33 | section balloon undercut | 37 |
| 34 | inflatable helical strip balloon | 35 |
| 35 | helically curved hardwood bar cross-sectional | 35, 37 |
| | view | |
| 36 | ⅜″ cable slots | 37 |
| 37 | ⅜″ cable wire | 37 |
| 38 | the central rectangular bottom slot | 37 |
| 39 | helical hardwood connecting adaptor | 36 |
| 40 | water tube wall | 35, 37 |
| 41 | radial elastomeric seal | 37 |
| 42 | lateral helical seal groove | 37 |
| 43 | container hardwood construction frame | 36 |
| 44 | amphibious water tanker container | 33, 34 |
| 45 | spherical tires | 2, 4, 21, 22 |
| 46 | longitudinal hardwood bars | 5, 21 |
| 47 | vertical lateral-oriented hardwood bars | 21 |
| 48 | water tanker structural square cavities | 21 |
| 49 | 6″ thick hardwood frame parallel plates | 22 |
| 50 | hardwood frame lower plate | 22 |
| 51 | longitude and lateral hardwood frame grid | 3 |
| 52 | hardwood frame cylindrical longitudinal | 3 |
| | tube hole | |
| 53 | lower hardwood frame parallel plates | 22 |
| 61 | water tanker hardwood end cover | 21, 36 |
| 62 | auxiliary compressed-air tanks | 21 |
| 63 | the external vertical end wall | 3, 21 |
| 64 | lower manual flow control valves | 6, 21, 22 |
| 65 | upper manual flow control valves | 6, 21, 22 |
| 67 | extension flexible water hose | 6 |
| 68 | Archimedes Screw pump's inlet port | 23 |
| 69 | Archimedes Screw pump's outlet port | 23 |
| 71 | amphibious tractor module hardwood frame | 10, 11 |
| 74 | ground-propelling pneumatic engine | 11, 12, 13, |
| | | 15, 16 |
| 75 | dual-rotation direction engine planetary | 13, 14, 15, |
| | transmission | 16, 18 |
| 76 | Caterpillar belt toothed driving wheel | 10, 11 |
| 78 | caterpillar double-toothed caterpillar | 19, 38 |
| | belt | |
| 81 | two top toothless caterpillar wheels | 7, 19, 39 |
| 82 | three bottom ground-toothed caterpillar | 7, 19, 39 |
| | belt wheels | |

### BRIEF DESCRIPTION OF THE SEVERAL VIEWS OF THE DRAWINGS

FIG. 1: Amphibious water tanker tractor-trailer top view

FIG. 2: Amphibious water tanker tractor-trailer side view

FIG. 3: Amphioxus water tanker tractor-trailer front view

FIG. 4: Amphibious water tanker tractor-trailer bottom view

FIG. 5: Amphibious water tanker tractor-trailer top-side view

FIG. 6: Amphibious water tanker tractor-trailer front view

FIG. 7: Amphibious tractor module top-front view

FIG. 8: Amphibious tractor module top view

FIG. 9: Amphibious tractor module front view

FIG. 10: Amphibious tractor module bottom-rear view

FIG. 21: Amphibious tractor module bottom view

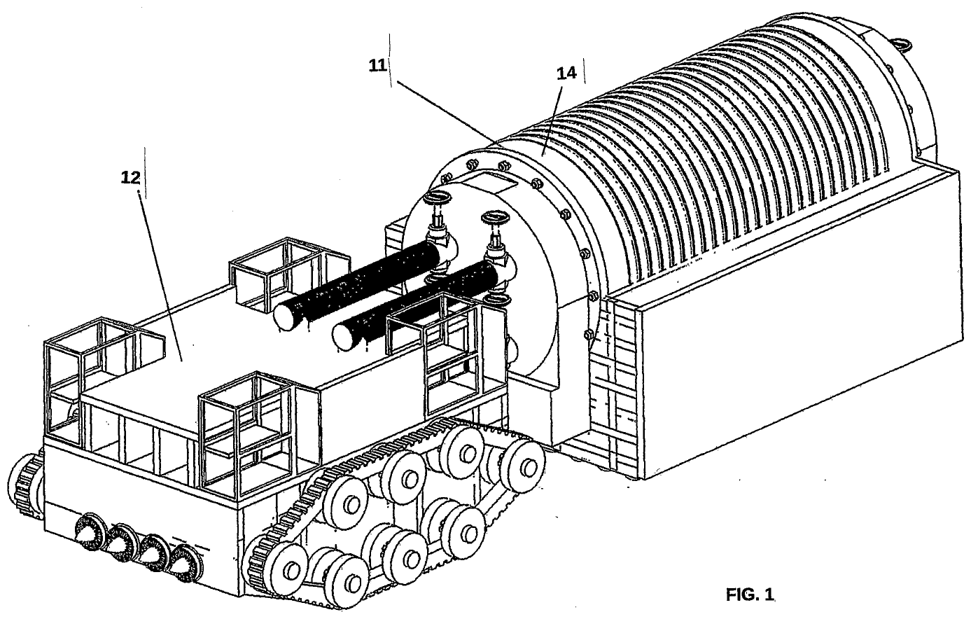

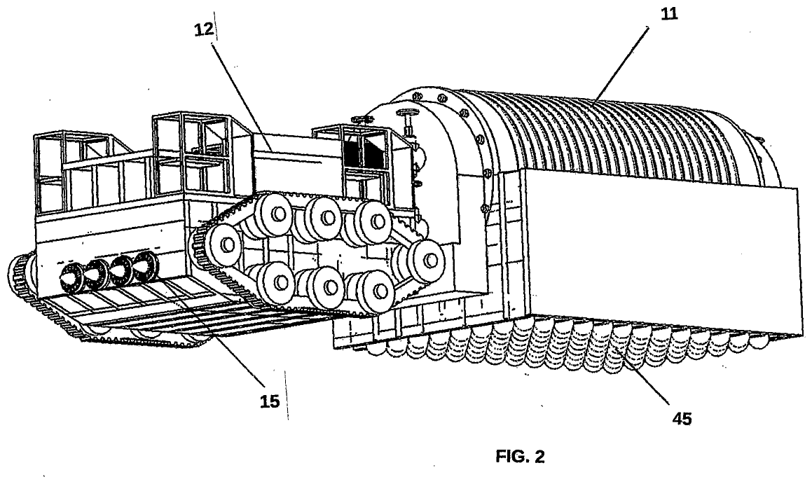

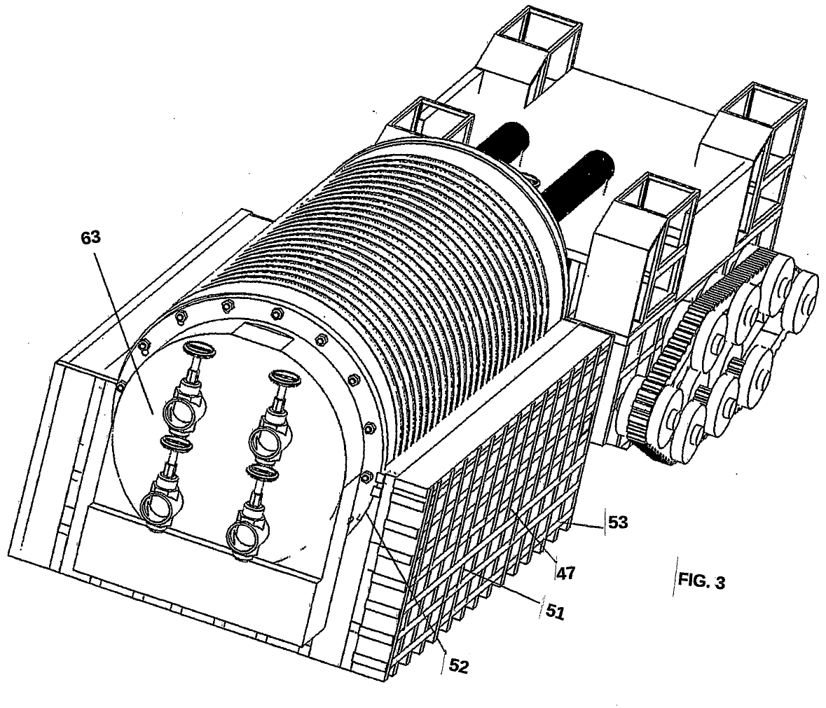

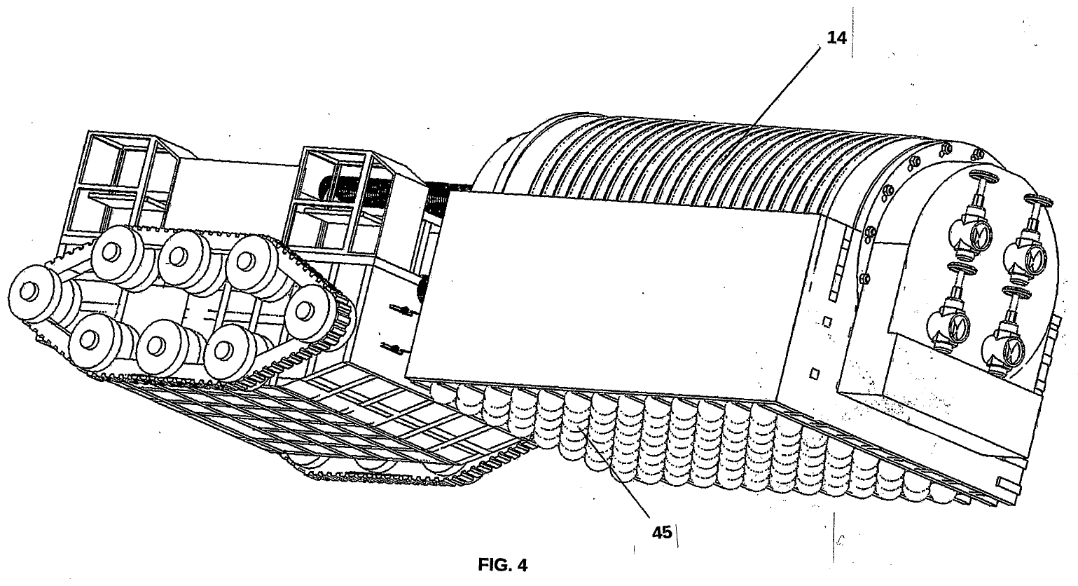

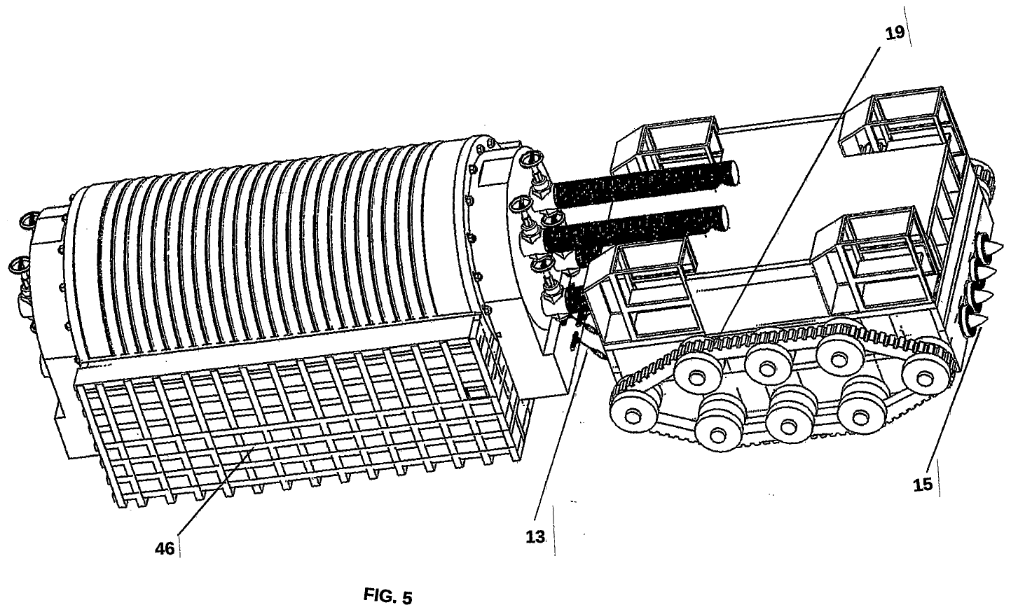

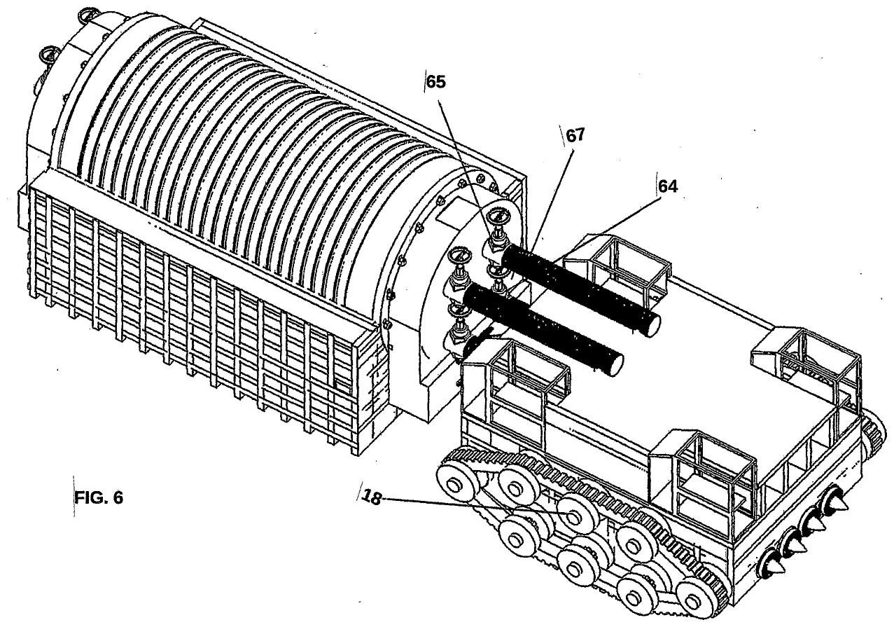

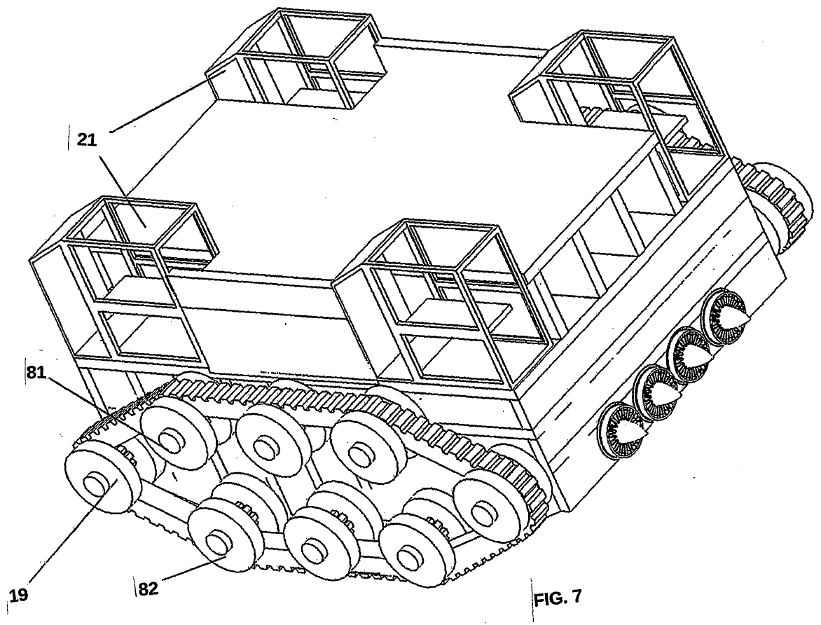

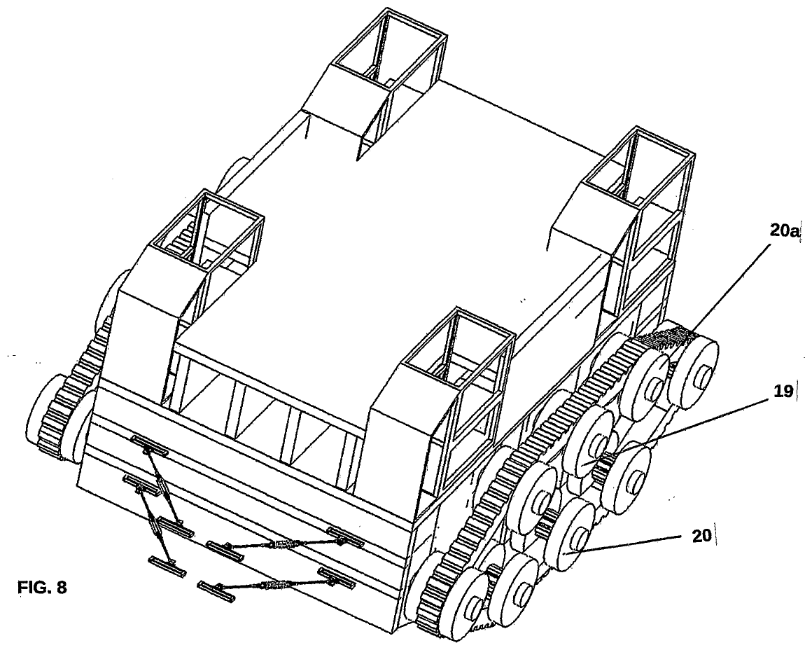

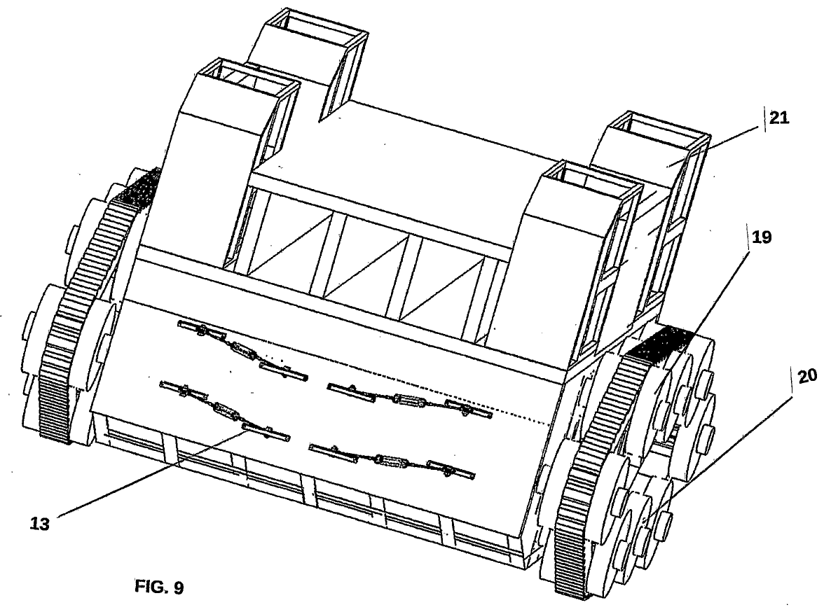

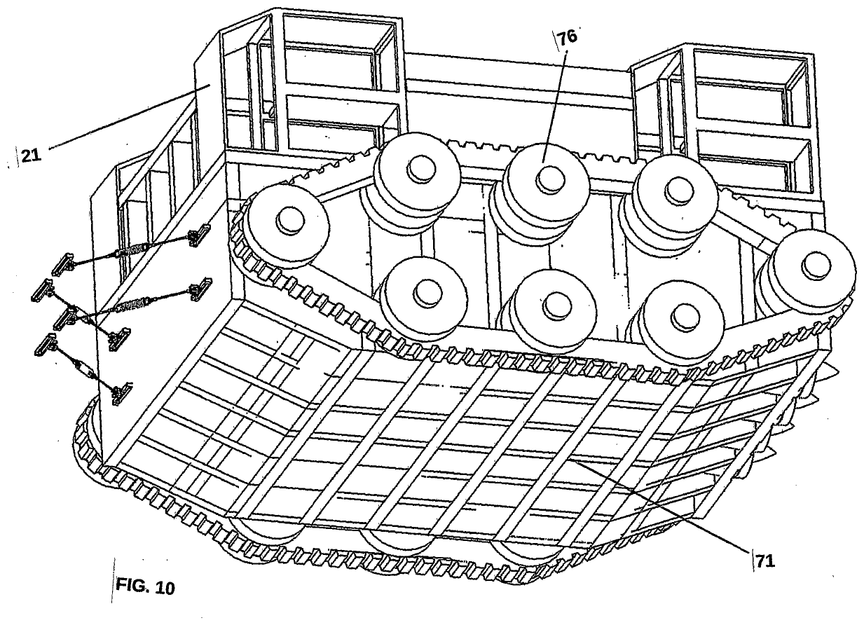

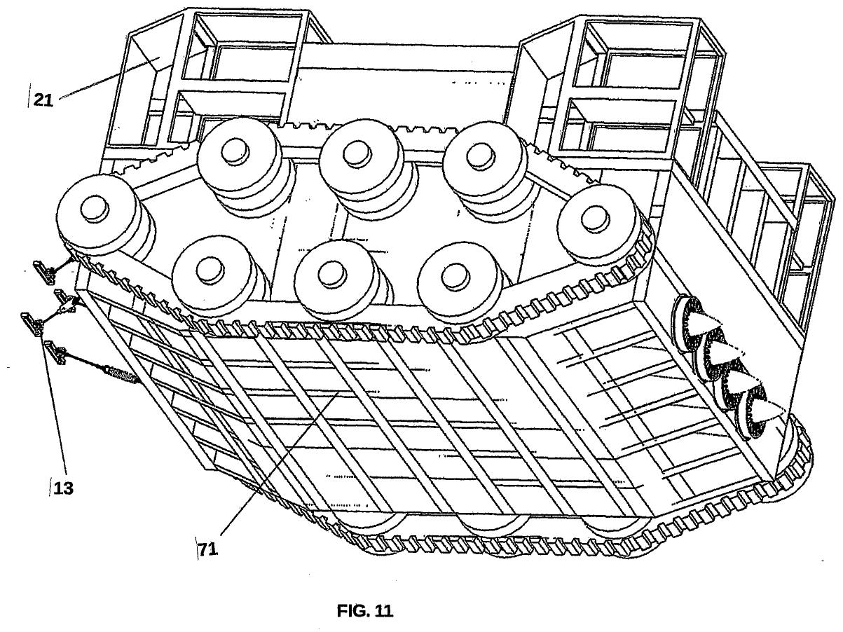

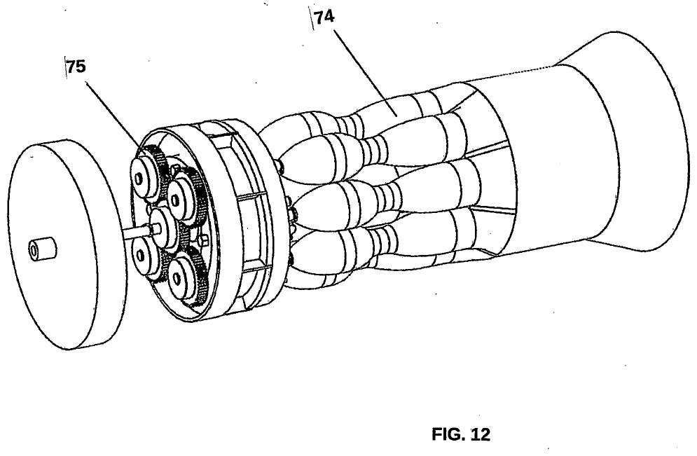

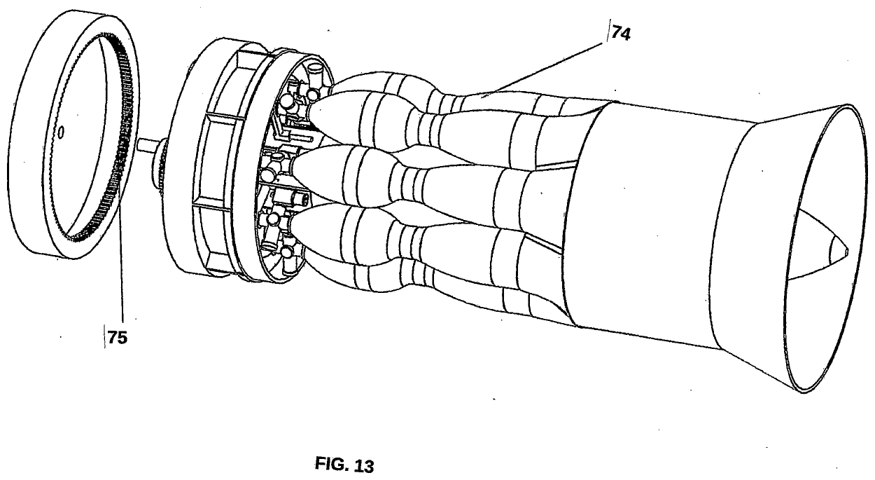

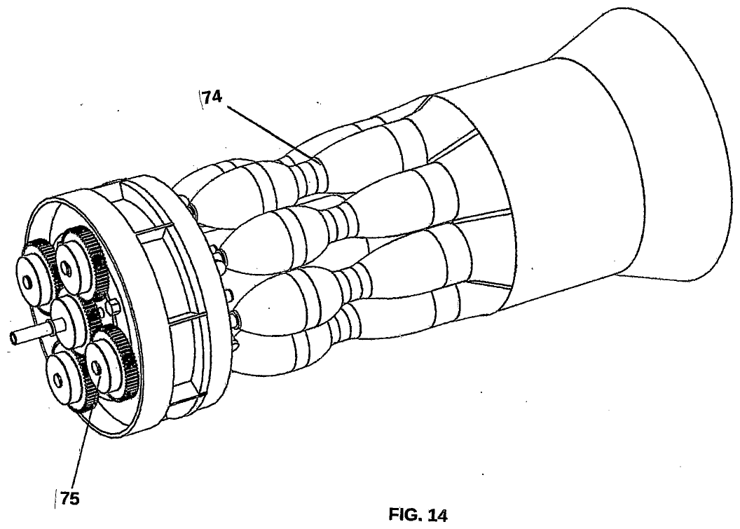

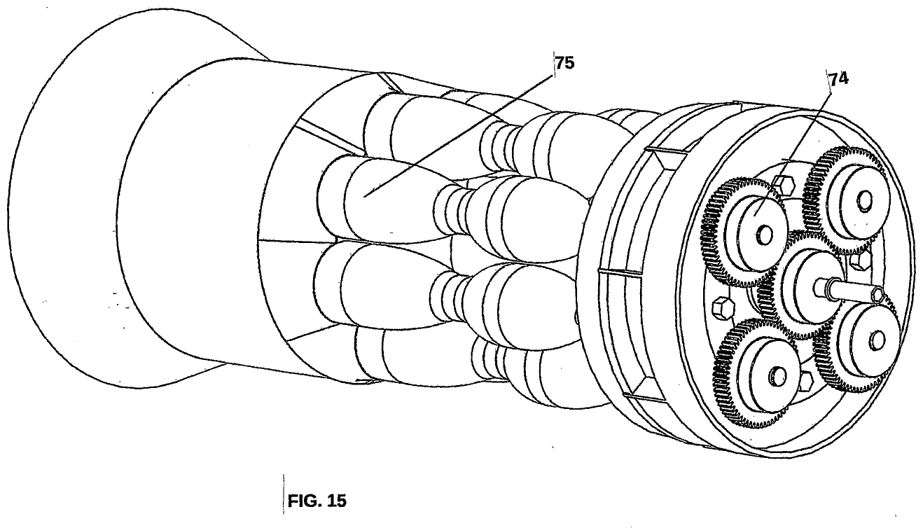

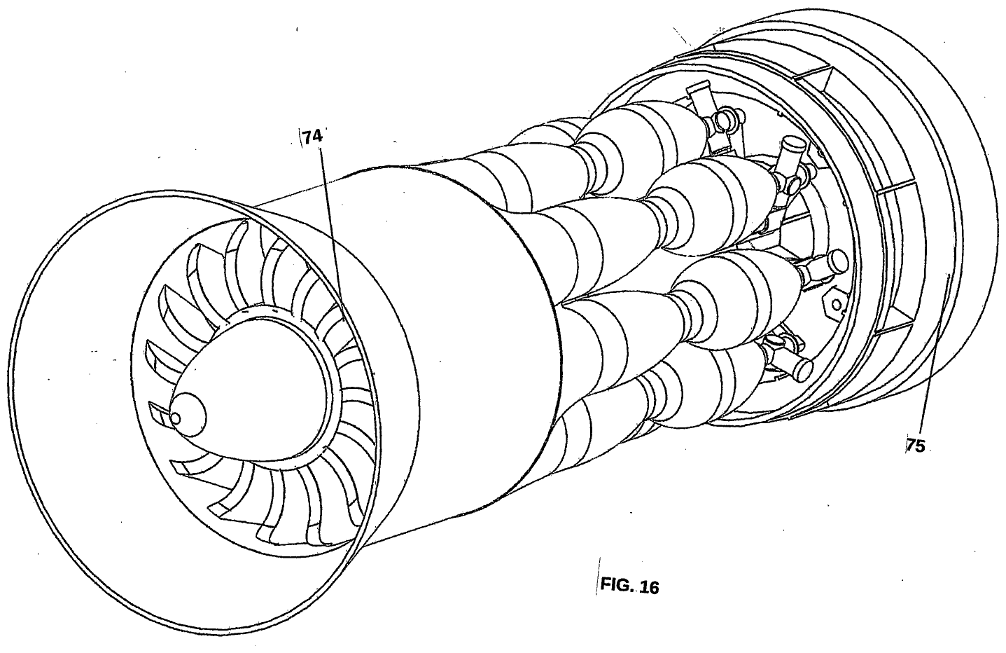

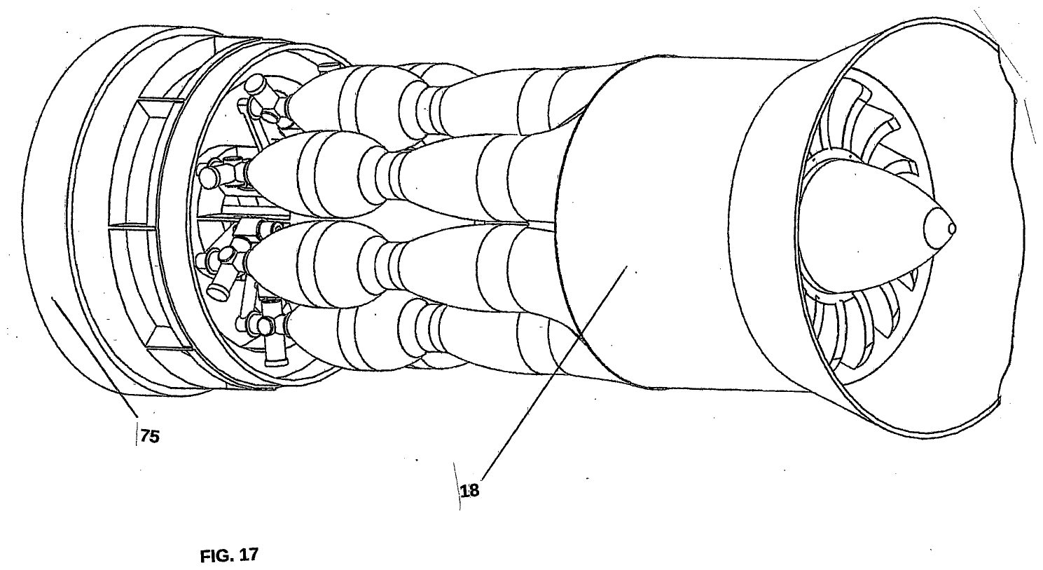

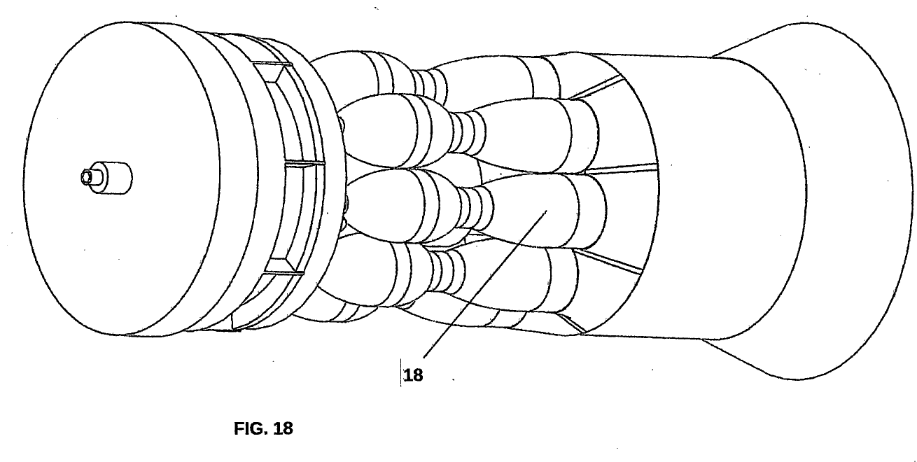

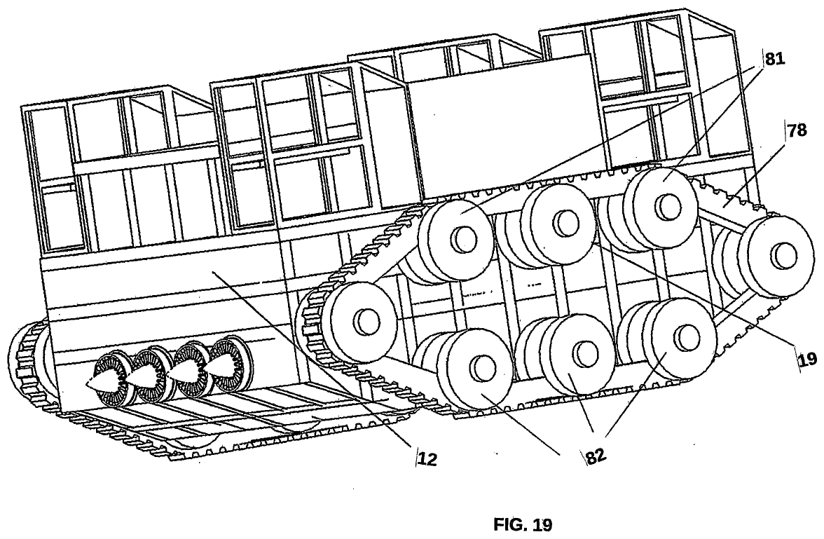

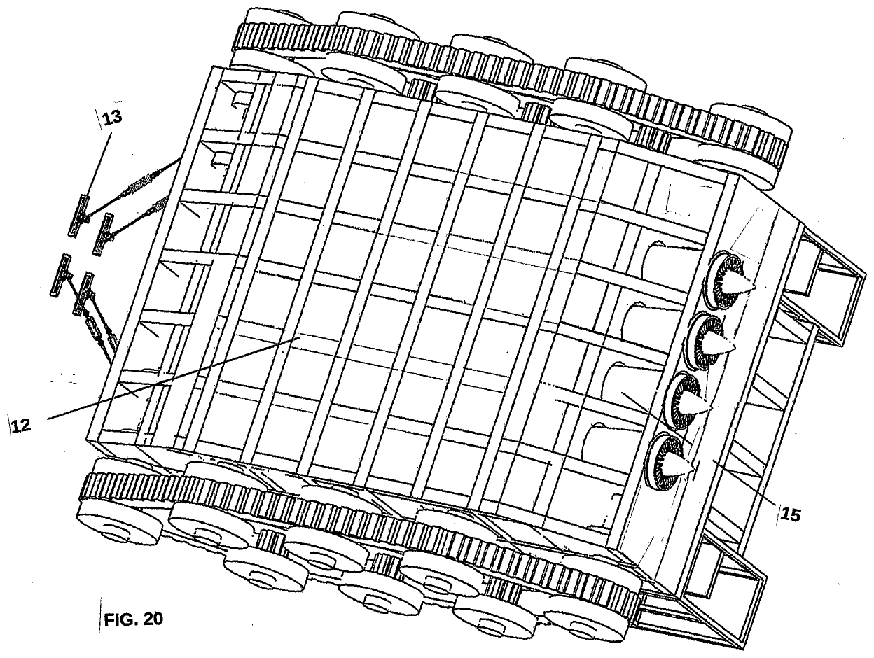

FIG. 12: Ground-propelling pneumatic engine with planetary gear

FIG. 13: Ground-propelling pneumatic engine planetary gear and internal gear

FIG. 14: Ground-propelling pneumatic engine planetary gear without internal gear

FIG. 15: pneumatic engine planetary gear without internal gear

FIG. 16: pneumatic engine planetary gear front view

FIG. 17: pneumatic engine planetary gear side view

FIG. 18: pneumatic engine planetary gear rear view

FIG. 19: Amphibious tractor module side-front view

FIG. 20: Amphibious tractor module bottom-front view with towing cables

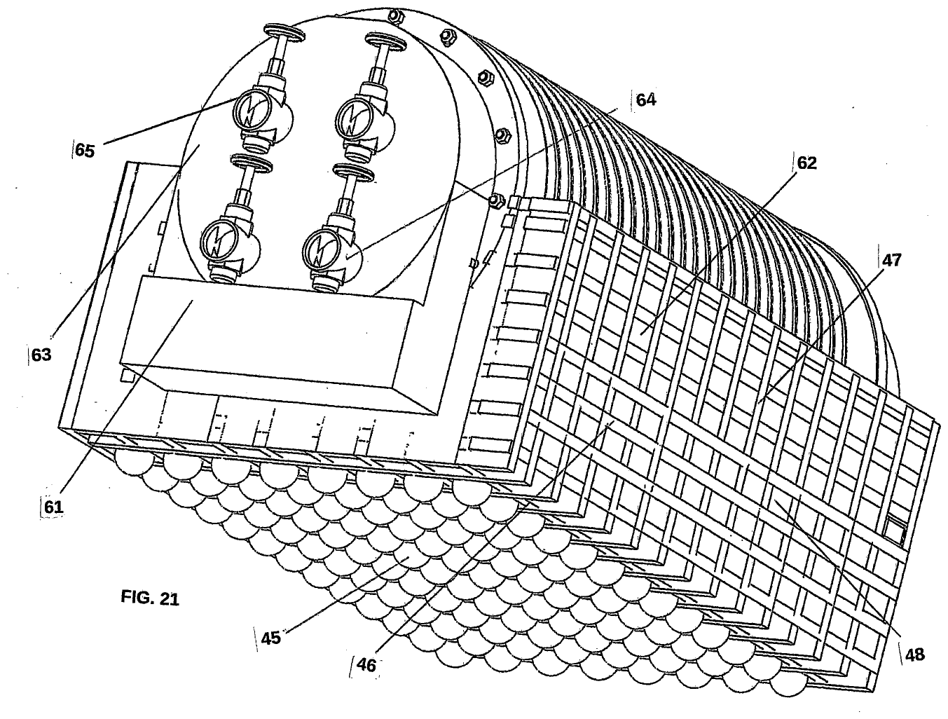

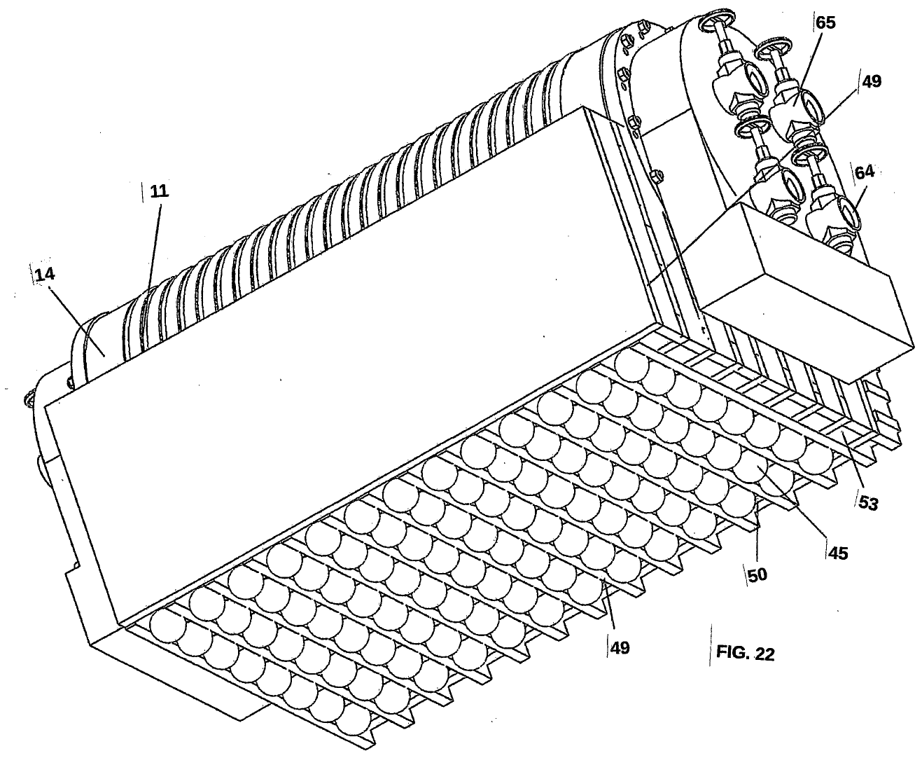

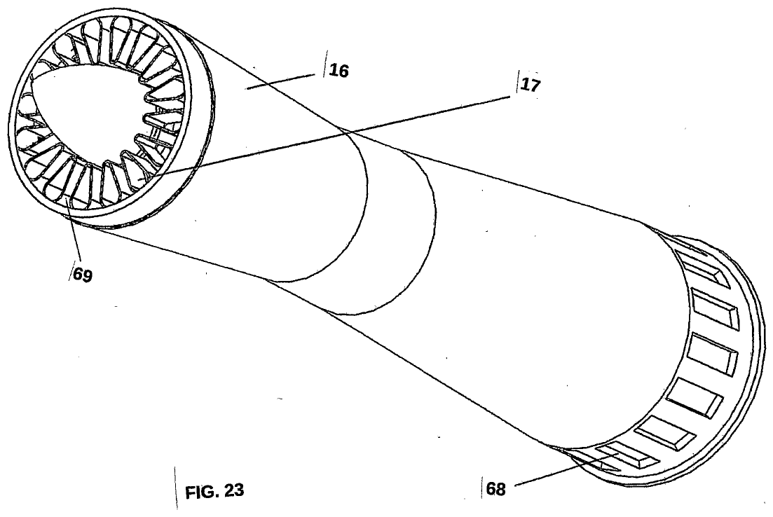

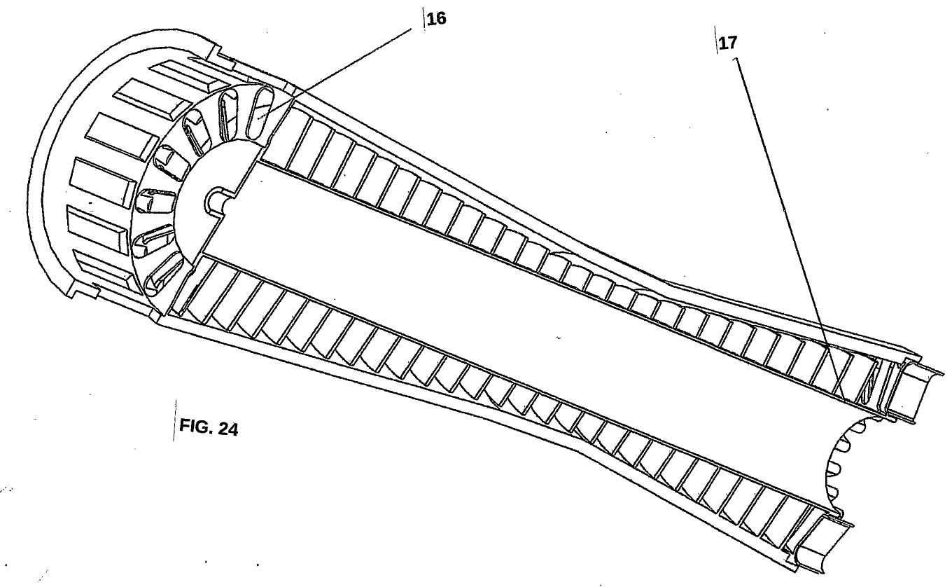

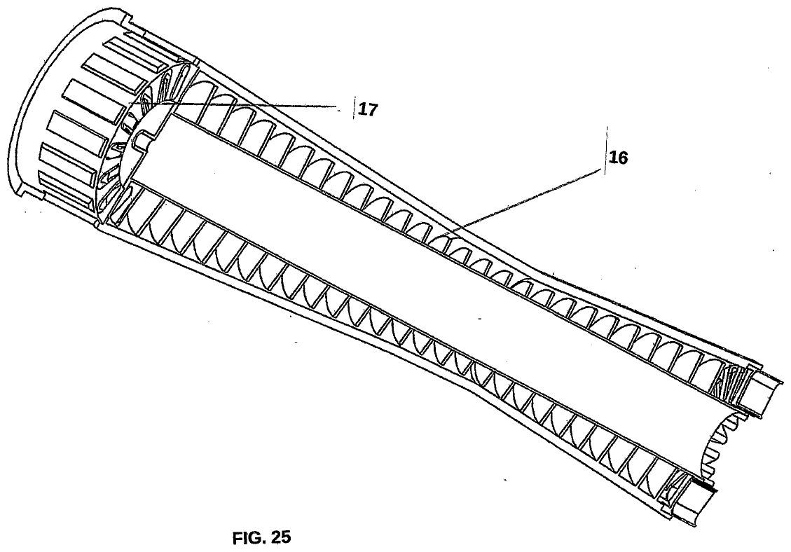

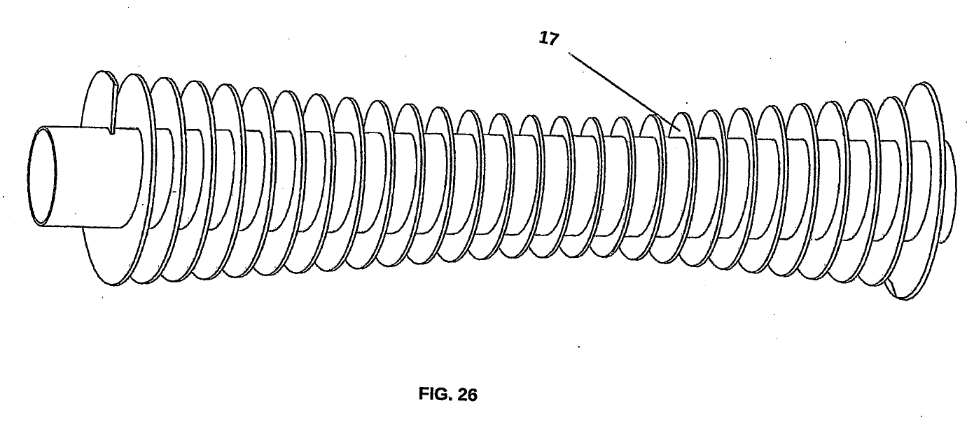

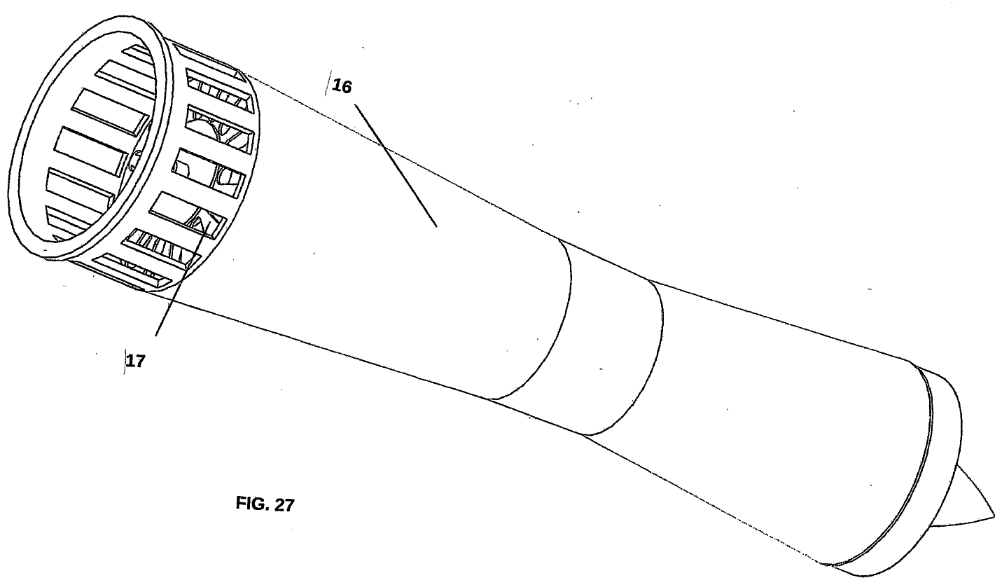

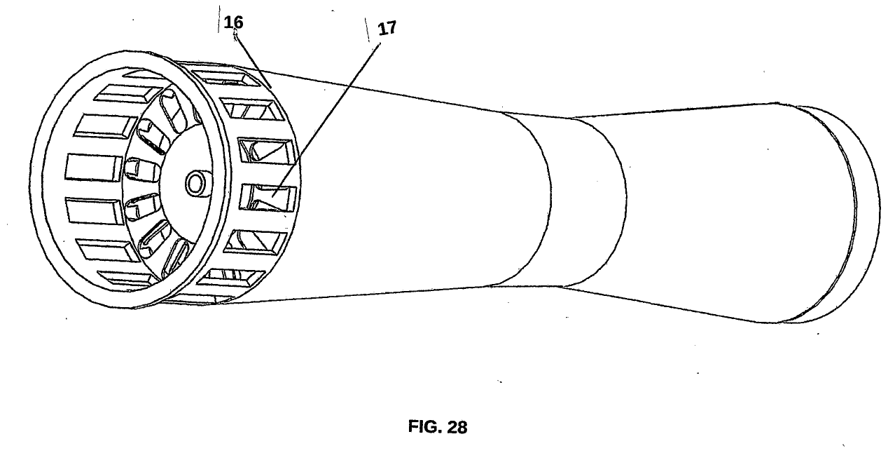

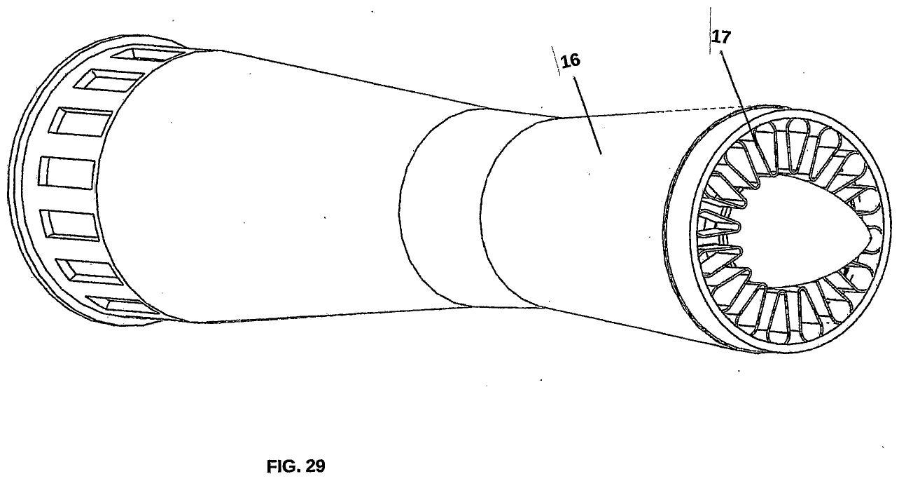

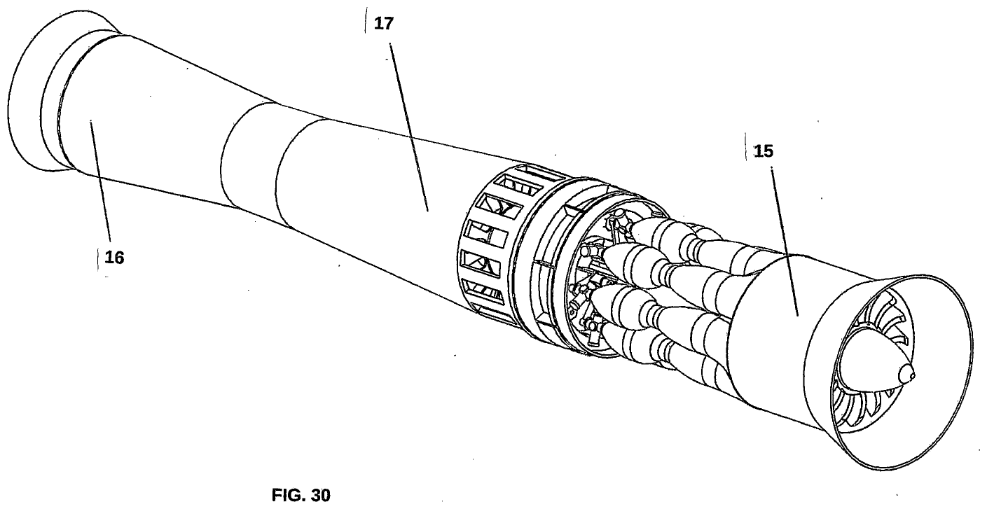

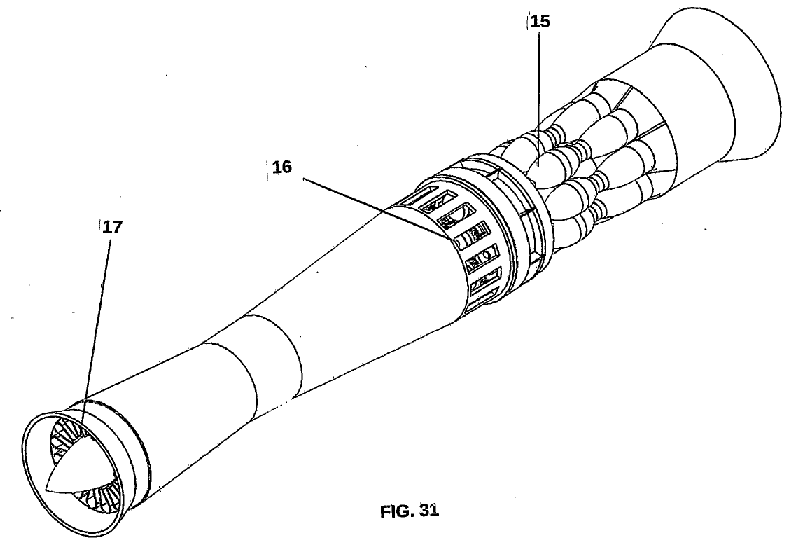

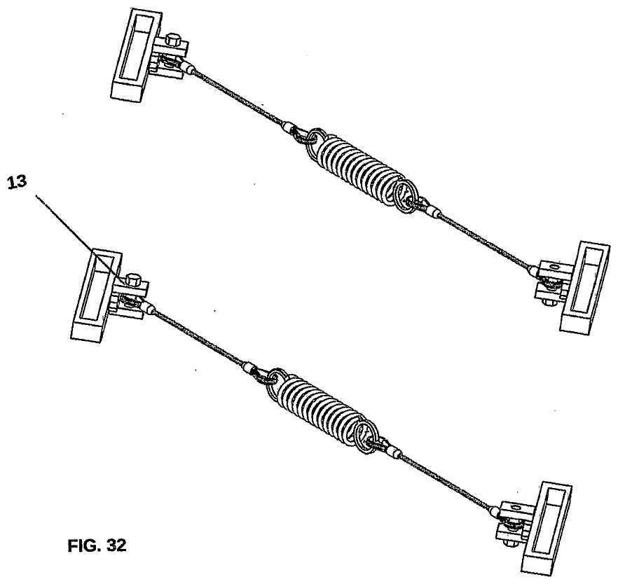

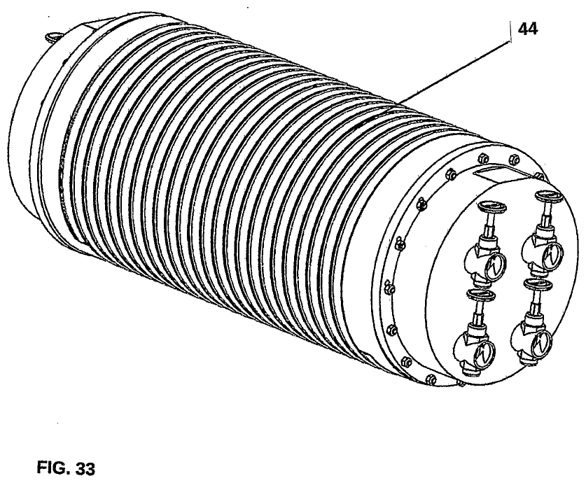

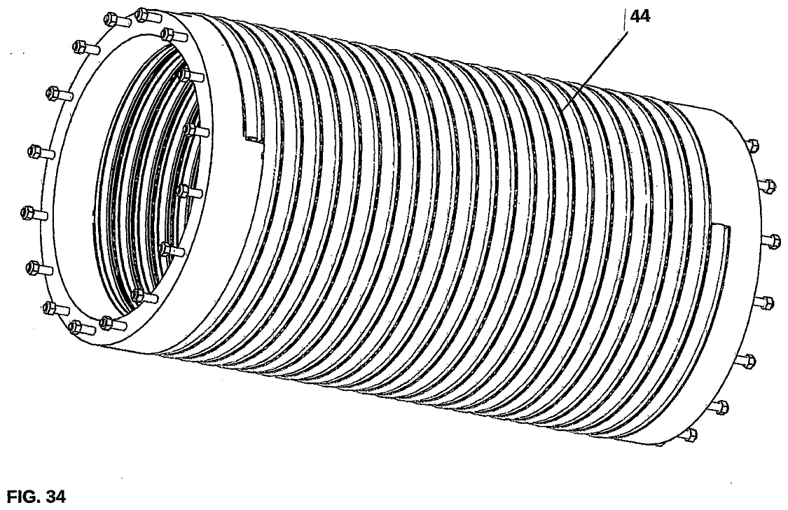

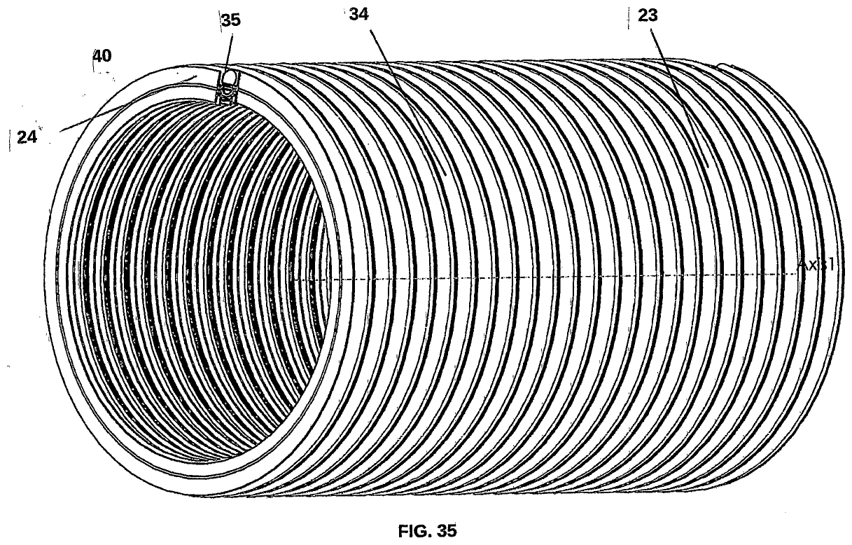

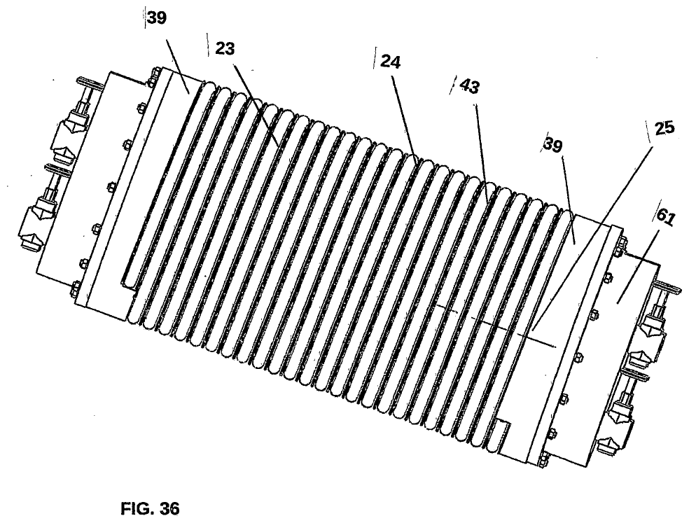

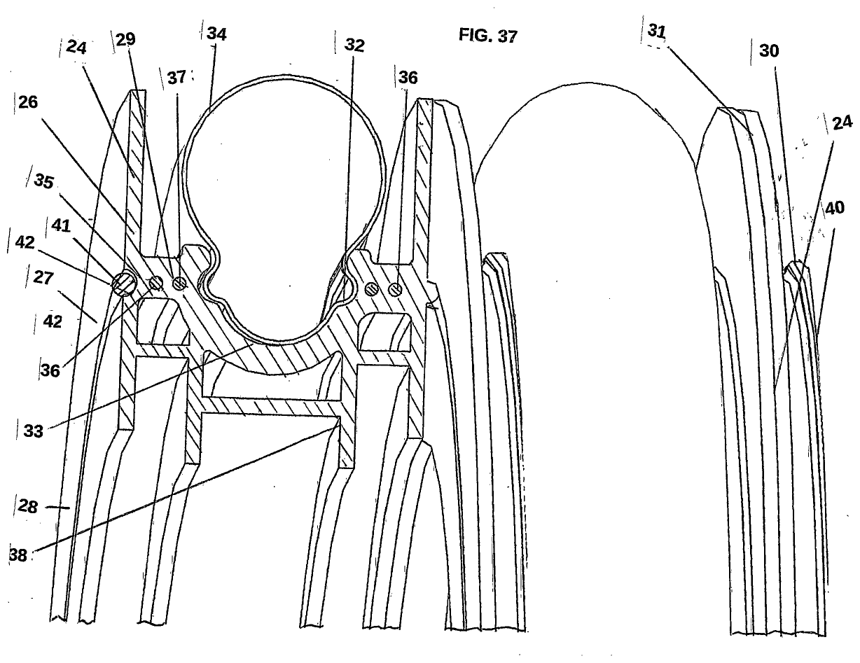

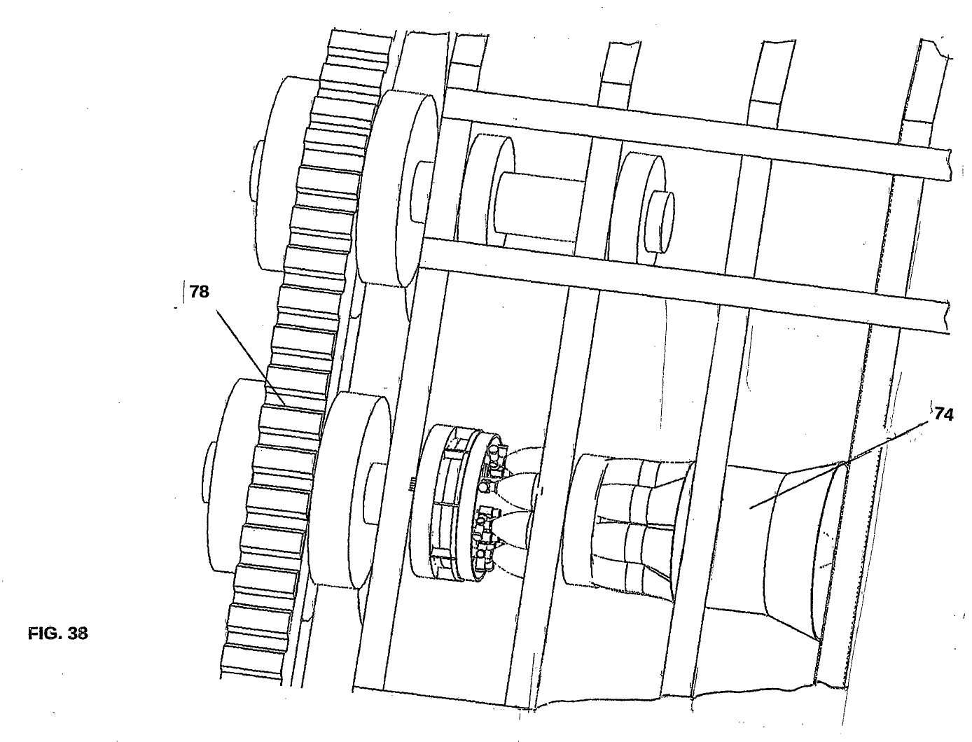

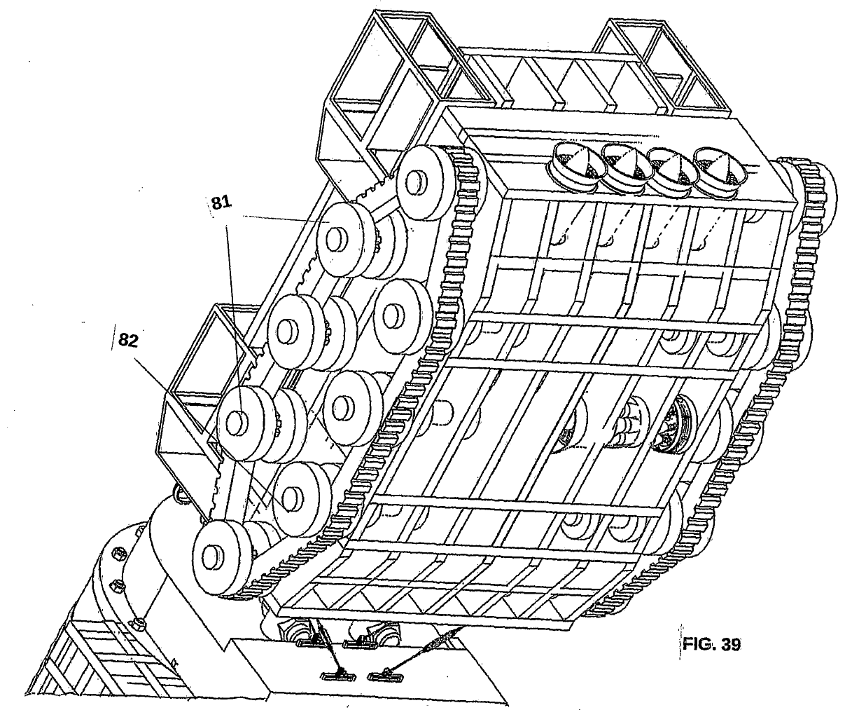

FIG. 21: Amphibious water tank trailer bottom view

FIG. 22: Archimedes Screw water pump waterjet truster top view

FIG. 23: Archimedes Screw water pump waterjet truster cross-section view

FIG. 24: Archimedes Screw water pump waterjet truster rear cross-section view

FIG. 25: Archimedes Screw water pump helical screw

FIG. 26: Archimedes Screw water pump waterjet truster rear view

FIG. 27: Archimedes Screw water pump waterjet truster front view

FIG. 28: Archimedes Screw water pump waterjet truster side view

FIG. 29: Archimedes Screw water pump waterjet truster top view

FIG. 30: pneumatic engine and Archimedes Screw pump waterjet truster side view

FIG. 31: pneumatic engine and Archimedes Screw pump waterjet truster top view

FIG. 32: tractor trailer towing cable assembly

FIG. 33: Amphibious water tanker container assembly front view

FIG. 34: Amphibious water tanker container with sold ends

FIG. 35: Amphibious water tanker container helical tube

FIG. 36: Amphibious water tanker container assembly side view

FIG. 37: Amphibious water tanker tube cross section

FIG. 38: Ground-propelling pneumatic engine with belt caterpillar

FIG. 39: tractor trailer with ground-propelling pneumatic engine caterpillar

### DETAILED DESCRIPTION OF THE INVENTION

An amphibious water tanker trailer 11 with an integral amphibious water tanker container 14 water with a storage capacity of 100 tons being powered and towed by an amphibious tractor module 12 and integral pumping capacity of 100,000 gallons per hour of flood water, water refilled from a river, reservoir, or a lake for firefighting and ocean seawater desalinated drinking water powered and towed by an amphibious tractor module.

The amphibious water tanker assembly comprises an amphibious water tanker trailer 11 that is attached with a towing wire cable assembly 13 and propelled by an amphibious tractor module 12 equipped with four water pumping and truster pneumatic engines 15 that operate four doubled convergence divergence tapered Archimedes Screw-type water pumps 16, together with Archimedes Screw-type water waterjet trusters 17 and In addition two ground caterpillar-propelling pneumatic engines 18 that power two side-mounted belt caterpillars 19 with eight-toothed wheeled belt drive assemblies 20. A module control panel 21 located on the amphibious tractor module 12 electronically controls the operational speed and power of the pumping pneumatic engines 15 and two ground caterpillar-propelling pneumatic engines 18. The four tapered Archimedes. Screw-type water pumps 16 with Archimedes Screw-type water waterjet trusters 17 propel the amphibious water tanker over a water reservoir, river, or lake while the two side-mounted belt caterpillars 19 with eight-toothed wheeled belt drive assemblies 20 provide hauling means for the amphibious tractor module 14 together with the towable amphibious water tanker trailer 11 on the land ground and in flooded areas. The amphibious water tanker trailer 11 is equipped with an amphibious water tanker container 14 of 100-ton water storage capacity with a water pumping rate capacity of 100,000 gallons per hour, which is critical for removing good water fast and for firefighting putting out fires in forests and dwelling areas.

The amphibious tractor module 12 with the amphibious water tanker trailer 11 and the towing cable assembly 13 can travel independently on land ground and flooded areas using the two caterpillar belt driving assemblies 20a. It can also float in water reservoirs and is self-propelled in flood water, rivers, and lakes. In addition, it can propel itself and refill its amphibious water tanker container 14 of 100 tons by self-pumping with water across a lake or a water reservoir with sweet or seawater.

The amphibious tractor module 12 uses integral auxiliary compressed-air tanks with the capacity to operate each of four of the pumping pneumatic engines 15 and each of the two ground-propelling pneumatic engines 18 continuously for 4 hours before being recharged with compressed air from an extra external air tank for an additional 4 continuous operations with a charging time of less than 5 minutes.

The amphibious tractor module 12 simultaneously pumps 100,000 gallons per hour and is self-propelled on land and water using the module's zero-emission and fossil-free pneumatic pulsed supersonic turbine air engines.

The amphibious water tanker with self-pumped water is stored in a cylindrical 4.5-meter diameter tanker water tube 23 with a total length of 10 meters. comprises:
a. a helically curved hardwood bar 24, with a longitudinal plane 25 through tube centerline curved hardwood bar cross-sections 26; each helically curved hardwood bar 24 bolted in its two curved hardwood bar open ends 27 to two identical concentric helically curved hardwood bar 28 with additional wooden support 29 bolted to each one, creating continuous multiple equal pitches helically curved hardwood bar turns 30 with a cross-sectional view through a longitudinal plane through the tube centerline 25 consists of
A. a right and left side joining flanges 31, a central semi-circular top balloon cut 32 with a balloon undercut 33 to accommodate, hold down, and radially locate a mating inflatable helical strip balloon 34.
a. The cross-sectional view 35 includes two symmetrical ⅜″ wire cable wide grooves 36 one inch deep with round ends, thereby supporting a wire cable ⅜%″ diameter wire cable 37.
b. a central rectangular slot bottom 38 of said cross-sectional view 35 wherein a helical hardwood connecting adaptor 39 is bolted to each of the two adjacent helically curved hardwood bars 24 connected together, and
c. Each helical turn 30 of the helically curved hardwood bar 241s bolted to the adjacent helical turn 30a, thereby merging together on their right and left flanges to create a sealed water tube wall 40.
d. a radial elastomeric seal 41 is seated in a lateral helical seal groove 42 and is squeezed between two adjacent hardwood bars 24, thereby creating a sealed cylindrical wall of 4.5-meter typical diameter and of typically 10 meters long.
e. along continuous cable, wire 37 of W diameter is helically wrapped into the two W cable slots 36 in the top of the helically curved hardwood bar 24, thereby providing radial stress resistance to the internal water pressure inside the amphibious water tank.
f. an air-inflatable helical strip balloon 34. A helical inflatable strip balloon made of woven fabric sealed with an elastomeric compound is wrapped on the helically curved hardwood bar's outer diameter center half circular top cut, and it expands into an undercut portion of the amount in the helically curved hardwood bar, thereby keeping it down in place.

B. A hardwood construction frame 43 that supports the amphibious water tanker container 44 comprises:
1. The container hardwood structural frame 43 is supported with 140 18″-diameter spherical tires 45 that can slide in either direction while being inflated to more than 100 psi air pressure, thereby supporting the water weight inside the container rated at 100-ton water load.
2. The container hardwood structural frame 43 consists of a vertical array of 8 longitudinal hardwood bars 46, 10 meters each meshed and bolted with an array of 20 vertical lateral-oriented hardwood bars 47, thereby creating an array of vertical 140 18″×18″ water tanker structural square cavities 48 parallel to the bottom ground surface.
3. Six 6″ thick hardwood frame parallel plates 49 with hardwood frame lower plate 50 located 8″ above the ground and extended upwards with 30″ spacing between each other and are laterally bolted to the longitude and lateral hardwood frame grid 51.
4. The lowest hardwood plate 50 located 8″ above ground creates a load-support ceiling and a rolling surface for the 140 18″-diameter tire spheres 45 that roll within the 18″×18″ vertical cavities 48.
5. The 140 spherical tires 45 inflated to 100 psi and comprised of fabric with compound and move support the water tanker over the ground, allowing the maneuvering and propelling of the water tank on the ground and prevented from moving out by spherical tire retainer bolted to the hardwood frame.
6. The spherical smooth-face tire rolls on the top ceiling 50 of the hardwood plate with tangential contact with the vertical longitudinal and lateral hardwood bars 18″×18″ pockets in the hardwood frame.
7. The spherical tires roll or slide over the bottom ground surface, allowing the heavy 100-ton amphibious water tanker to move with limited friction on the ground in any direction.
8. The cylindrical water tank's helical hardwood wall length is typically 10 meters, with the helically slanted end and each helically slanted end bolted to a circular peripheral portion of the solid cylindrical end with an external left end and right end perpendicular to the centerline of the cylindrical water tank.
9. A water tanker hardwood end cover 61 is bolted to the flanged circular periphery of the solid hardwood cylindrical end at each side of the water tanker, thereby creating a sealed water tanker volume of 100 cubic meters.
10. auxiliary compressed-air tanks 62 located in the longitudinal spaces between the horizontal hardwood plates and the longitudinal and lateral hardwood bar array, thereby providing compressed air for the inflation of the helical strip balloon 36 through a balloon inflation manual control valve, which controls the floatation of the amphibious water tanker trailer in the water reservoir, lake, river, and flooded area.
11. Each amphibious tanker trailer end cover 61 comprises a cylindrical sealed hardwood with an axial flanged open end bolted to the solid hardwood end 58, and the external vertical end wall 63 has two lower manual operated low control valves 64 and two upper manual operated flow control valves 65.
12. The lower manual flow control valves 64 are connected with an extension flexible connection hose 67 to the Archimedes Screw pump's 16 inlet port 68, flowing water from the amphibious water tanker trailer for firefighting.
13. The upper manual low control valves 65 are connected with an extension flexible connection hose 67 to the Archimedes Screw pump's 16 inlet port 68.

C. The amphibious tractor module 12 is equipped with four pneumatic engines 15 that operate four doubled convergence divergence tapered Archimedes Screw-type water pumps 16 with waterjet trusters 17 pumps and, in addition, two ground-propelling pneumatic engines 18 that power two side-mounted belt caterpillars 19 with eight-toothed wheeled belt drive assemblies 20.

The amphibious tractor module 12 is connected with a metallic high-strength towing wire cable assembly 13 that is secured by a bolted connection to the amphibious water tanker trailer, comprising:
1. An amphibious tractor module hardwood frame 71 consists of eight longitudinal hardwood bars and six lateral hardwood bars, each 6″ width, bolted together to six horizontal hardwood parallel plates spaced 30 apart to create an array with 30″×30 cross-sectional spaces that support the propelling pneumatic air-turbine engines.
2. A ground-propelling system comprising two ground-propelling pneumatic engines 18 that power two side-mounted belt caterpillars 19 with eight-toothed wheeled belt drive assemblies 20.
   a. Two ground-propelling pneumatic engines 74 with dual-rotation direction planetary transmission 75 mounted perpendicularly to the longitudinal centerline of the amphibious tractor module and on the right and left sides of the longitudinal centedrine
   b. The power takeoff shaft of each engine faces away from the longitudinal centerline, and it is keyed to a toothed belt driving wheel 76, which transfers the rotary power to the eight-wheel caterpillar belt system 20.
   c. a caterpillar double-toothed belt 78 running on eight chain-toothed wheels, of which three toothed wheels run on the ground, two toothed wheels are raised at a belt-slanted angle of 30 degrees off the ground, thereby the amphibious tractor module propels the amphibious water tanker longitudinally and laterally at electronically controlled speed with a climbing slanted belt over a stepped ground for mounting over a trailer.
   d. The two top toothless caterpillar belt wheels 81 on both sides of the center driving toothed wheel are hinged to the module hardwood frame, and they can swivel around a swivel shaft for belt installation and belt-tightening using clamping bolts to the frame.
3. Four pneumatic engines 15 that operate four doubled convergence divergence tapered Archimedes Screw-type water pumps 16 with waterjet truster pumps 17 with dual-rotation direction planetary transmission 75 are used for pumping flood water into the amphibious water tanker container and also out of the container for firefighting. The four pumps are used for pumping good water from the ground level into the amphibious water tanker container with CW rotation of the inner engine power takeoff shaft output adaptor through the input extension flexible water hose 67. The pump is used for pumping water out from the amphibious water tanker container with CCW rotation of the outer engine power takeoff shaft output adaptor through the output extension flexible water hose 67.
The four pneumatic engines 15 that operate four doubled convergence divergence tapered Archimedes Screw-type water pumps 16 with waterjet truster pumps 17 with dual-rotation direction planetary transmission 75 are used for propelling the amphibious water tanker trailer. With the speed and power control of the four engines set by the control panel, the water jet trust outlet provides trust to the amphibious tractor module and also control of the direction and lateral control with the amphibious water tanker trailer towed behind with the wire cable assembly 13.

1. An amphibious water tanker trailer with a water tanker container of a storage capacity of 100 tons being powered and towed by an amphibious tractor module and integral pumping capacity of 100,000 gallons per hour of good water, water pumped from a river, reservoir, or a lake for firefighting and ocean seawater desalinated drinking water, attached with a towing wire cable assembly to an amphibious tractor module equipped with four pneumatic engines that operate four doubled convergence divergence tapered Archimedes Screw water pumps with waterjet truster pumps and with two laterally mounted ground-propelling pneumatic engines that power two side-mounted belt caterpillars with eight-toothed wheeled belt drive assemblies, thereby forming a system of amphibious tractor module with the amphibious water tanker trailer and said towing cable assembly that travel independently on land ground and flooded areas using the two caterpillar belt driving assemblies, and is self-propelled in flood water, rivers, and lakes, comprising,
The amphibious water tanker trailer with amphibious water tanker container comprising,
a. Amphibious water tanker container comprises,
i. a cylindrical large meters diameter tanker water tube, comprises,
1. a helically curved hardwood bar, with a longitudinal plane through tube centerline rectangular cross-sections; each helically curved hardwood bar bolted in its two open ends to two identical concentric helically bent bars with additional wooden support bolted to each one, creating continuous multiple equal pitches helically curved hardwood bar turns with a cross-sectional view through a longitudinal plane through the tube centerline consists of
2. a right and left side joining flanges, a central semi-circular top cut with an undercut to accommodate, hold down, and radially locate a mating inflatable helical strip balloon, and
3. The cross-sectional view includes four symmetrical grooves one inch deep with round ends, thereby supporting a wire cable, and
4. a central rectangular slot on the bottom side of said cross-sectional view wherein a connecting adaptor is bolted to each one of the two adjacent helically curved hardwood bars connected together and
5. Each helical turn of the helically curved hardwood bar is bolted to the adjacent helical turn, thereby merging together on their right and left flanges to create a sealed wall, and
6. a radial elastomeric seal is seated in a lateral helical groove and is squeezed between two adjacent hardwood bars, thereby creating a sealed cylindrical long wall of and
7. along continuous metallic wire is helically wrapped into the four ⅜″ slots in the top of the helically curved hardwood bar, thereby providing radial stress resistance to the internal water pressure inside the amphibious water tanker container and
8. A helical inflatable strip balloon made of woven fabric sealed with an elastomeric compound is wrapped on the helically curved hardwood bar's outer diameter center half circular top cut, and it expands into an undercut portion of the amount in the helically curved hardwood bar, thereby keeping it down in place, and
ii. A hardwood construction frame that supports the water tank cylindrical container comprises:
1. The hardwood structural frame is supported with 140 18″-diameter spherical tires that can slide in either direction while being inflated to 100 psi air pressure, thereby supporting the water weight inside the container rated at 100-ton water load and
2. The hardwood structural frame consists of a vertical array of 8 longitudinal-oriented hardwood bars, meshed and bolted with an array of 20 vertical-lateral-oriented hardwood bars, thereby creating an array of vertical 140 square cross-section cavities parallel to the bottom ground surface, and
3. Six thick hardwood plates with lower plate located above the ground, and extended upwards with 30 spacing between each other, and are laterally bolted to the longitude and lateral hardwood frame grid and providing supporting ceiling to said sphere balls, and
4. The 140 spherical tires inflated to high pressure and comprised of fabric with compound and move support the water tanker over the ground, allowing the maneuvering and propelling of the water tank on the ground and prevented from moving out by spherical tire retainer bolted to the hardwood frame, and
5. The spherical smooth-face tire rolls on the top ceiling of the hardwood plate with tangential contact with the vertical longitudinal and lateral hardwood bars 18″×18″ pockets in the hardwood frame, and
6. The spherical tires roll or slide over the bottom ground surface, allowing the heavy 100-ton amphibious water tanker to move with limited friction on the ground in any direction, and
7. The cylindrical water tank's helical hardwood wall length is typically 10 meters, with the helically slanted end and each helically slanted end is bolted to a circular peripheral portion of the solid cylindrical end with an external left end and right end perpendicular to the centerline of the cylindrical water tank, and
8. A water tanker hardwood end cover is bolted to the flanged circular periphery of the solid hardwood cylindrical end at each side of the water tanker, thereby creating a sealed water tanker volume of 100 cubic meters and
9. auxiliary compressed-air tanks located in the longitudinal spaces between the horizontal hardwood plates and the longitudinal and lateral hardwood bar array, thereby providing compressed air for the inflation of the helical strip balloon 36 through a balloon inflation manual control valve, which controls the floatation of the amphibious water tanker trailer in the water reservoir, lake, river, and flooded area, and
10. Each amphibious tanker trailer end cover comprises a cylindrical sealed hardwood with an axial flanged open end bolted to the solid hardwood end, and the external vertical end wall has two lower manual operated low control valves and two upper manual operated flow control valves and
11. The lower manual flow control valves are connected with an extension flexible connection hose to the Archimedes Screw pump's inlet port, flowing water from the amphibious water tanker trailer firefighting, and
12. The upper manual flow control valves are connected with an extension flexible connection hose to the Archimedes Screw pump's inlet port,
C. The amphibious tractor module is equipped with four pneumatic engines that operate four doubled convergence divergence tapered Archimedes Screw-type water pumps with waterjet truster pumps and, in addition, two ground-propelling pneumatic engines that power two side-mounted belt caterpillars with eight-toothed wheeled belt drive assemblies. and
The amphibious tractor module is connected with a metallic high-strength towing wire cable assembly that is secured by a bolted connection to the amphibious water tanker trailer, comprising:
4. An amphibious tractor module hardwood frame consists of eight longitudinal hardwood bars and six lateral hardwood bars, bolted together to six horizontal hardwood parallel plates spaced 30 apart to create an array with cross-sectional spaces that support the propelling pneumatic air-turbine engines, and
5. A ground-propelling system comprising two ground-propelling pneumatic engines with planetary gear transmission having either CW or CCW rotation adaptor, thereby powering two side-mounted belt caterpillars with eight-toothed wheeled belt drive assemblies, comprises
a. a caterpillar double-toothed belt running on eight chain-toothed wheels, of which three toothed wheels run on the ground, two toothed wheels are raised at a belt-slanted angle off the ground, thereby the amphibious tractor module propels the amphibious water tanker longitudinally and laterally with a climbing slanted belt over a stepped ground for mounting over a towing trailer, and
b. The two top toothless caterpillar belt wheels on both sides of the center driving toothed wheel are hinged to the module hardwood frame thereby, they can swivel around a swivel shaft for belt installation and belt-tightening using clamping bolts to the frame and
6. Four pneumatic engines with planetary gear transmission having either CW or CCW rotation adaptor powering our doubled convergence divergence tapered Archimedes Screw-type water pumps with waterjet truster pumps with dual-rotation direction planetary transmission, thereby pumping flood water into the amphibious water tanker container and also out of the container for firefighting.
7. Four pneumatic engines with planetary gear transmission having either CW or CCW rotation adaptor powering four doubled convergence divergence tapered Archimedes Screw-type water pumping flood water from the ground level into the amphibious water tanker container with CW rotation of the inner engine power takeoff shaft output adaptor through the input extension flexible water hose, thereby pumping water out from the amphibious water tanker container with CCW rotation of the outer engine power takeoff shaft output adaptor through the output extension flexible water hose.
8. The four pneumatic engines with planetary gear transmission having either CW or CCW rotation adaptor powering four doubled convergence divergence tapered Archimedes Screw-type water pumps with waterjet truster, thereby propelling the amphibious tractor module together with the amphibious water tanker trailer.
9. Amphibious tractor module control panel, with the speed and power control of the four pneumatic engines' water jet trust outlet, thereby providing trust to the amphibious tractor module and controlling the lateral maneuvering of the amphibious tractor module and the amphibious water tanker trailer towed behind it with the wire cable assembly:
